(19) United States
(12) Patent Application Publication
(10) Pub. No.: US 2026/0228552 A1
(43) Pub. Date: Aug. 6, 2026

(54) APPARATUS AND METHOD FOR LARGE LANGUAGE MODEL (LLM) REINFORCEMENT LEARNING WITH HETEROGENEOUS PROCESSORS

(71) Applicant: Intel Corporation, Santa Clara, CA (US)

(72) Inventors: Yang Wang, Los Angeles, CA (US); Ke Ding, Saratoga, CA (US); Chendi Xue, AUSTIN, TX (US); Daniel Huang, Fremont, CA (US)

(73) Assignee: Intel Corporation, Santa Clara, CA (US)

(21) Appl. No.: 19/632,146

(22) Filed: Mar. 27, 2026

(51) Int. Cl. G06N 3/092; G06N 5/04

(52) U.S. Cl. CPC G06N 3/092; G06N 5/04

(57) ABSTRACT

A system and method for LLM reinforcement learning with heterogeneous processors. An example system comprises: a first one or more processors to perform large language model (LLM) inference operations based on a current model version and to generate corresponding training data samples; a second one or more processors having a heterogeneous architecture relative to the first one or more processors, the second one or more processors configurable to perform reinforcement learning operations using the corresponding training data samples to update model weights for the current model version; and a weight transfer engine to provide point-to-point communication channels between the first one or more processors and the second one or more processors, the second one or more processors to transmit the model weights over the point-to-point communication channels to the first one or more processors.

### BACKGROUND

### Field of the Invention

This invention relates generally to the field of computing systems. More particularly, the invention relates to an apparatus and method for large language model (LLM) reinforcement learning with heterogeneous processors.

### Description of the Related Art

Reinforcement learning (RL) has been used to fine-tune large language models (LLMs) to enhance the reasoning capabilities of LLMs, significantly increasing performance across various workloads such as mathematics, competitive coding, software engineering, and general agentic workflows. Recent performance advances are based on scaling up RL and RL-enhanced domain specific models are being released by the open-source model community. Moving forward, the majority of artificial intelligence (AI) compute power is expected to be consumed on reinforcement learning techniques for AI model training.

However, current RL implementations are inefficient, with low hardware resource utilization and surging costs for training runs.

### BRIEF DESCRIPTION OF THE DRAWINGS

A better understanding of the present invention can be obtained from the following detailed description in conjunction with the following drawings, in which:

FIG. 1 illustrates an example embodiment including a training engine running on a plurality of general purpose graphics processing units (GPGPUs) and a rollout engine running on a plurality of accelerators.

FIG. 2A illustrate an implementation in which each training GPGPU is configured to register for processing a specific shard of weights.

FIG. 2B illustrate an implementation in which each rollout engine worker initiates remote direct memory access (RDMA) operations to access weight shards in response to an indication that new weights are available.

FIG. 2C illustrate an implementation in which each rollout engine worker concatenates shards to form full weights, and then slice the full weights in accordance with a local model.

FIG. 3 illustrates a method in accordance with some embodiments of this disclosure.

FIG. 4 illustrates an example accelerator configurable within a rollout engine in accordance with some embodiments.

### DETAILED DESCRIPTION

A heterogeneous reinforcement learning (RL) architecture, in accordance with embodiments of this disclosure, operates training engines on high-performance processing resources, such as general purpose graphics processing unit (GPGPU) architectures, and operates rollout engines on relatively lower power and lower cost accelerators, such as tensor or matrix processing units, to fully exploit the distinctive capabilities and price points of these device types. In some embodiments described herein, a weight transfer engine enables communication between the high-performance GPGPU processing resources and relatively lower power tensor accelerators. In particular, the weight training engine may support remote direct memory access (RDMA) transfers of weight updates from the training engine to the rollout engine.

In some implementations, the weight transfer engine includes a control plane network to support a rollout service protocol as described herein, including weight and sample versioning to enable synchronized RL, asynchronized RL, and other techniques such as partial rollouts. The weight transfer engine of these embodiments also includes a high-bandwidth data plane network to support point-to-point transfer of updated weights from training engine instances to rollout engine instances. The training engine instances and rollout engine instances are also referred to herein as “workers.”

Modern RL systems for large language models (LLMs) typically include three components: (i) a rollout engine using an LLM for training data collection, (ii) a training engine using the collected training data to update the LLM weights, and (iii) a weight transfer engine that transfers the newly updated weights from the training engine to rollout engine. These three components work as a three-stage synchronous or asynchronous pipeline for each iteration of the RL training process, with the rollout engine running LLM inference generations, the training engine performing LLM training, and the weight transfer engine running collective communication operations between the rollout engine and the training engine.

Modern RL systems tightly integrate these three components within homogeneous compute architectures, even though the training engine and the rollout engine have disparate computing requirements. The training engine, for example, executes sophisticated training algorithms, which requires high-performance processing resources with a high density of computing FLOPS (floating point operations/second), high bandwidth scale up and scale out interconnects, and a sophisticated, highly customizable software stack to support different training algorithms and diverse parallelization strategies. In contrast, the rollout engine runs LLM generation workloads which are memory bandwidth-intensive, requiring modest scale up interconnects, and a simpler but efficient software stack. The tightly coupled homogeneous compute architectures used for current RL systems are incapable of leveraging the distinctive characteristics of these different components, resulting in under-utilization of processing resources and increased cost.

Embodiments of this disclosure include a disaggregated heterogeneous architecture configured in accordance with the distinctive computing characteristics of a reinforcement learning (RL) system for LLM training and inference. In general terms, RL is a branch of machine learning where an agent learns to make decisions by performing actions in an environment to maximize a cumulative reward. Unlike supervised learning, which relies on a labeled dataset of correct answers, RL is based on trial and error. The RL process generally follows a synchronous or asynchronous pipeline in which the rollout engine runs inference to produce samples and the training engine generates new weights which improve the model based on those samples. The updated weights are transferred to the rollout engine, and the model in the rollout engine (the agent) is updated for the next iteration.

In various implementations of this disclosure, the training engine is executed on high-performance data parallel processing resources, such as general purpose graphics processing unit (GPGPU) and operates rollout engines on lower power and lower cost AI accelerators, specifically configured for inferencing. A weight transfer engine, in communication with these different hardware architectures supports a rollout service protocol as described herein, including weight and sample versioning to enable synchronized RL, asynchronized RL, and other techniques such as partial rollouts. The weight transfer engine of these embodiments also supports high-bandwidth point-to-point transfer of updated weights from training engine instances to rollout engine instances.

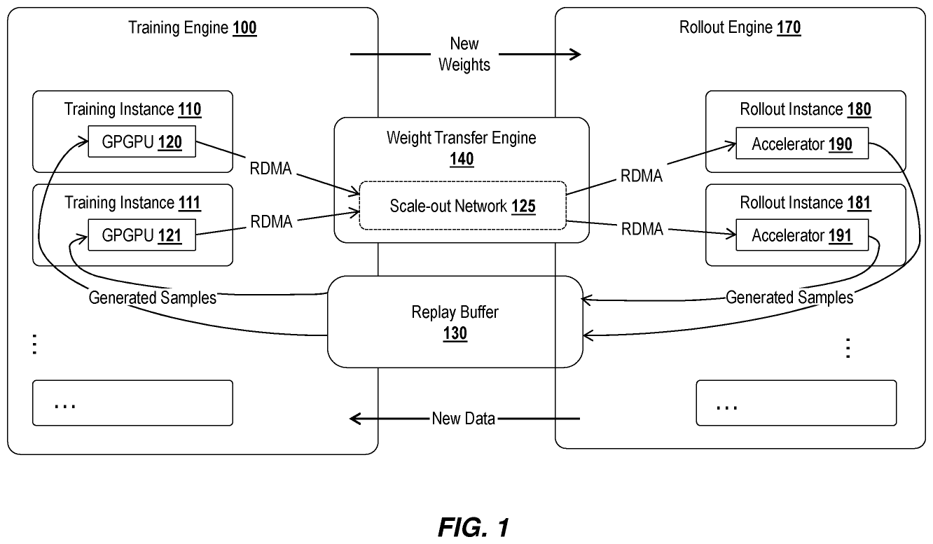

FIG. 1 illustrates an example implementation of a training engine 100 and a rollout engine 170 in accordance with embodiments of this disclosure. The training engine 100 includes a plurality of training instances 110-111 running on a corresponding plurality of high-performance GPGPUs 120-121, which may be individual GPGPUs or partitioned slices of one or more GPGPUs. As used herein, a “GPGPU” refers to any processor designed for massively data parallel operations, such as the multi-dimensional tensor operations used for generative AI applications (e.g., convolutions, matrix multiplications, etc.). Note that the GPGPUs described herein do not necessarily include graphics processing pipelines with dedicated graphics hardware such as rasterization circuitry, texture sampling circuitry, and depth testing circuitry. The GPGPUs 120-121 include a large number of compute cores (e.g., ALUs or groups of ALUs) arranged in clusters for executing parallel threads of a workgroup (e.g., in accordance with a single instruction multiple thread (SIMT) and/or single instruction multiple data (SIMD) arrangement). Examples of GPGPUs 120-121 include the Nvidia Blackwell or Hopper tensor processing architectures and the AMD MI300 and MI400 series AI accelerators. Of course, the underlying principles of this disclosure are not limited to any particular model of GPGPU.

In operation, a plurality of rollout instances 180-181 of the rollout engine 170 execute a large language model (LLM) on a corresponding plurality of accelerators 190-191, which generate training data samples. The accelerators 190-191 may be individual accelerator devices or partitioned slices of one or more accelerator devices. The training data samples are provided to the plurality of training instances 110-111 via a replay buffer 130 or using other communication mechanisms. Examples of these rollout instance accelerators 190-191 include Intel Gaudi 3 accelerators designed for high-performance inference of LLMs and generative AI.

The training instances 110-121 running on the GPGPUs 120-121 use the generated training samples as input to update the LLM weights (which “train” the LLM). A weight transfer engine 140 transfers the newly-updated weights from the training engine 100 to the rollout engine 170. Thus, the training engine 100 and rollout engine 170, in combination with the replay buffer 130 and weight transfer engine 140, operate as a multi-stage synchronous or asynchronous reinforcement learning (RL) pipeline. In each iteration of the RL training process, the rollout engine 170 executes LLM inference samples, the training engine 100 performs LLM training, and the weight transfer engine 140 provides updated weights to the rollout engine 170.

In some implementations, the weight transfer engine includes a scale-out network 125 with DMA circuitry for accessing the updated weights and for providing the new weights to the rollout instances 180-181 running on accelerators 190-191 via remote direct memory access (RDMA) operations (e.g., reading and writing the weights from shared local memory, shared caches, and/or shared address ranges in a system memory). In some embodiments described herein, the scale-out-network 125 includes a data plane for performing the RDMA operations and a control plane supporting the rollout service protocol features described herein, including weight and sample versioning to enable synchronized RL, asynchronized RL, and partial rollouts.

In some instances, the training engine 100 is configured to run on one or more nodes, illustrated as training instances 110-111, each equipped with a high-performance GPGPU 120-121 (or a defined slice thereof), respectively (e.g., an Nvidia H100, H200 (Hopper architecture), or B200 (Blackwell architecture)). Similarly, the rollout engine 170 is configured to run on one or more nodes, illustrated as rollout instances 180-181, each equipped with an accelerator 190-191 (or a defined slice thereof) for performing training data collection in accordance with an LLM using lower power and lower cost compared to performing the same operations on the GPGPUs 120-121. In some implementations, the accelerators 190-191 are Intel Gaudi 3 AI accelerators, although the underlying principles of this disclosure are not limited to any particular accelerator model. The number of instances implemented in the training engine 100 and the rollout engine 170 is implementation dependent.

In some embodiments, the scale-out network 125 implements an asynchronous, vendor-agnostic point-to-point communication library for weight transfer from the training engine 100 to the rollout engine 170 (e.g., periodically and/or on-demand). By way of example, and not limitation, the scale-out network 125 may include an InfiniBand network or an RDMA over converged Ethernet (ROCE) network. Unlike standard Ethernet, InfiniBand uses a switched fabric architecture with RDMA specifically designed for data centers. RoCE also leverages RDMA to provide performance comparable to InfiniBand while using a standard Ethernet infrastructure. In some embodiments, however, the scale-out network 125 may include a standard Ethernet network (e.g., operated with a TCP/IP stack). Some embodiments of the scale-out network 125 implement a modular plug-in architecture, operable with various types of GPGPUs, accelerators, and host processors (e.g., implementing the NVIDIA Inference Xfer Library (NIXL) in some embodiments).

Embodiments which perform asynchronous reinforcement learning as described herein, run iterations of the training engine 100 and rollout engine 170 to with significantly greater efficiency than synchronous implementations without compromising convergence. Thus, while the heterogeneous architecture in FIG. 1 supports both synchronous and asynchronous RL, asynchronous RL typically provides greater efficiency and eliminates pipeline bubbles. For synchronous reinforcement learning, the rollout engine 170 will immediately stream finished rollout requests to the replay buffer 130, so that the training engine 100 can start the training loop without waiting for all the requests to complete, which can reduce pipeline bubbles.

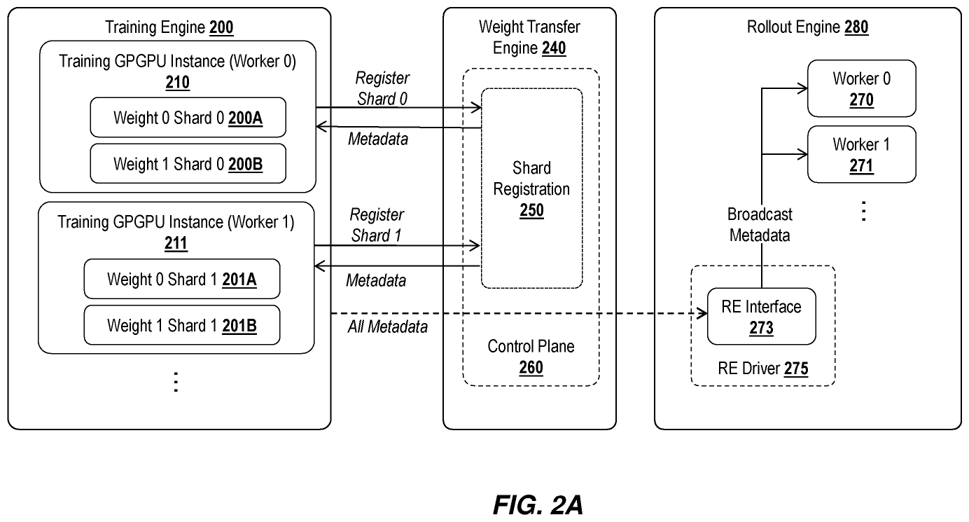

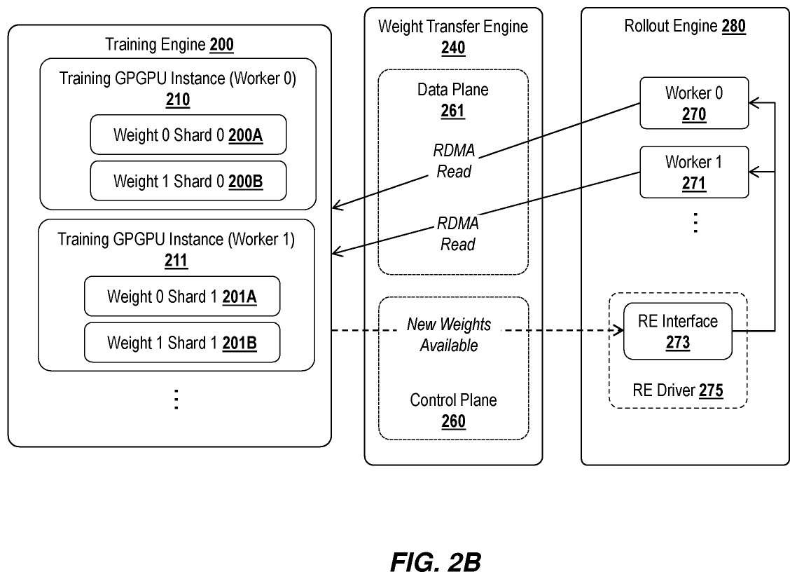

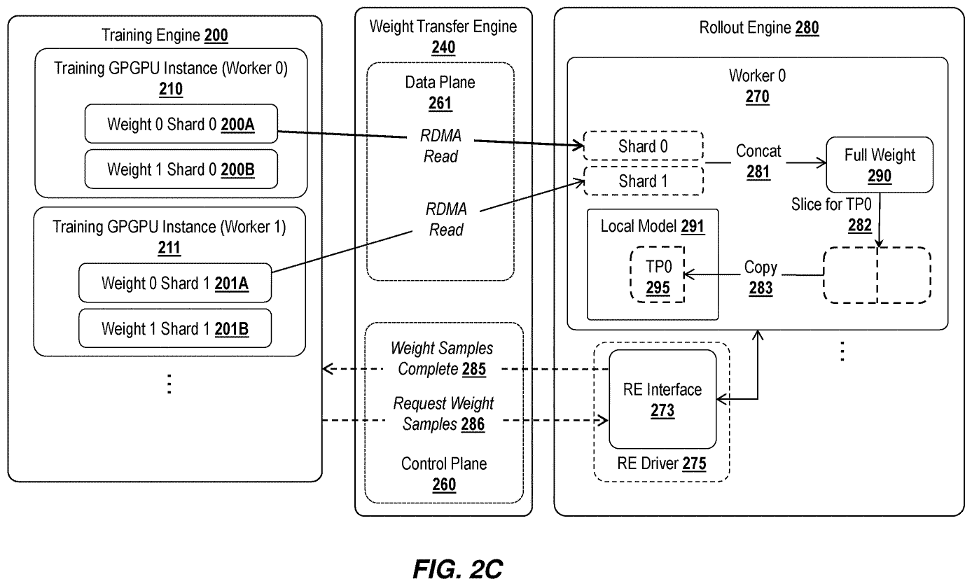

FIGS. 2A-C illustrate a training engine 200 comprising a plurality of training GPGPUs 210-211 and a rollout engine 280 cooperatively coupled via a weight transfer engine 240. The rollout engine 280 executes a plurality of workers 270-271 (e.g., rollout engine instances 180-181 executing on accelerators 190-191 as shown in FIG. 1). In these implementations, the plurality of training GPGPUs instances 210-211 are configured to operate collectively in a sharded training environment. In particular, rather than every GPGPU holding a complete copy of the model weight tensor, each GPGPU instances 210-211 holds only a unique portion of the total weight tensor, referred to as a “shard.” In the illustrated example, GPGPU instance 210 generates weights 200A-B of shard 0 and GPGPU generates weights 201A-B of shard 1.

While only two training GPGPU instances 210-211 are illustrated for simplicity of explanation, the training engine 200 may include hundreds or thousands of training GPGPU instances, which generate a large number of weight updates in each iteration.

As described further below, embodiments of the scale-out network 125 support a control plane 260 for controlling how and when weight data should move between the training engine 200 and the rollout engine 280 (e.g., metadata exchange, rollout engine interface protocols, job creation, weight versioning) and a data plane 261 comprising a high-performance weight transfer pipe for moving weight tensors in response to RDMA requests (e.g., RDMA read and write operations and sharding/concatenation of model weights).

As indicated in FIG. 2A, each GPGPU instance 210-211 is configured as an individual training engine worker which registers its specific shard of weights into shard registration logic 250 of the weight transfer engine 240. In response to the shard registrations, the shard registration logic 250 generates corresponding metadata, including an RDMA address associated with each shard. In some implementations, the training engine 200 collects the metadata for all ranks and all weight tensors and transmits it via the control pane 260 to a rollout engine interface 273 exposed by a rollout engine driver 275, which broadcasts the metadata to all rollout engine workers 270-271. As mentioned, each rollout engine worker 270-271 may comprise a separate rollout instance, such as rollout instances 180-181 in FIG. 1.

As indicated in FIG. 2B, in some embodiments, the training engine 200 signals the rollout engine interface 273 via the control plane 260 when a new version of weights is ready for collection. Each rollout worker 270-271, upon receipt of the notification from the rollout engine interface 273, initiates RDMA reads via the data plane 261 to fetch corresponding weight shards directly from the training GPGPU instances 210-211.

As shown in FIG. 2C, using worker 270 as a representative example, each rollout engine worker 270-271 fetches multiple corresponding shards over the data plane 261, i.e., shard 0 200A and shard 1 200B, from different training GPGPU instances 210-211. Once a rollout worker 270 has collected all the necessary shards for a specific weight tensor, it performs a concatenation operation 281 to form the full weight 290. The rollout worker 270 then slices (re-shards) 282 the corresponding weight 290 according to its own local tensor-parallel (TP) rank requirements, and copies 283 the sliced weight into its local model 291, as TPO 295 in the illustrated example. To prevent memory spikes, the updates for different weight tensors may be performed serially.

Once all workers 270-271 in the rollout engine 280 have completed updating the weight tensor(s), the rollout engine interface 273 transmits a message 285 via the control plane 260 to the training engine 200 indicating that the corresponding weight samples are available. The training engine 200 subsequently (e.g., in response to the message), transmits a request 286 for new weight samples. As described with respect to FIG. 1, the weight samples may be streamed through the replay buffer 130 (e.g., retrieved via a GET/request/sample command of the rollout service protocol). Each sample may be bundled with version metadata (e.g., weight_version_used) so the training engine 200 can verify the sample's validity before initiating the training iteration.

Thus, in these embodiments, the rollout engine interface 273 is a vendor-agnostic interface to the control-plane 260 which ensures data correctness across the heterogeneous hardware of the training engine 200 and rollout engine 280. In some implementations, the rollout engine interface 273 implements a Hypertext Transport Protocol (HTTP)/JavaScript Object Notation (JSON)-based interface protocol in which all operations are idempotent to ensure reliability during failures. In these embodiments, the interface protocol is structured in accordance with: (i) the Immutable Object Model; (ii) defined state machine lifecycles; (iii) version management; and (iv) robustness and failure handling capabilities.

With respect to the Immutable Object Model, the rollout engine interface 273 manages the reinforcement learning (RL) lifecycle through three versioned, first-class objects: Job, Weight, and Request.
Job: A job object represents a full RL training run and owns a sequence of monotonically increasing weight versions and all associated rollout requests.
Weight: A weight object is an immutable snapshot of model parameters identified by a weight_version. In some implementations, the weight object includes shard descriptors that provide the shard memory locations for RDMA reads, as described with respect to FIGS. 2B-C.
Request: A Request object (sometimes referred to as a RolloutRequest) is a task initiated by the training engine 200 that specifies constraints such as the acceptable range of weight versions and whether mixed-version samples are allowed.

A state machine lifecycle is defined for each object, which transitions through a specific set of states in response to explicit events to ensure system-wide synchronization. An example set of state machine lifecycles for a Job object, a Weight object and a Request object is provided in Table A.

TABLE A

| Object | State Transitions | Key Milestone |
|---|---|---|
| Job | CREATED → RUNNING → | Explicitly marked |
| | FINISHED | FINISHED by the |
| | | user. |
| Weight | CREATED → AVAILABLE → | AVAILABLE once all |
| | EXPIRED | rollout workers have |
| | | fetched the weight. |
| Request | CREATED → RUNNING → | FAILED if there is a |
| | SUCCEEDED/FAILED | timeout or weight |
| | | constraint violation. |

With respect to version management, the rollout engine interface 273 implements version constraints and safety protocols which provide strict guarantees to the training engine 200 regarding the data it consumes, including, but not limited to:
Weight Version Used: Every generated sample is explicitly tagged with the weight_version_used.
Setting can_mix=false: Ensures that a single trajectory is generated using exactly one weight version; if an update occurs mid-generation, the task is either completed under the old version or restarted.
Setting can_mix=true for Partial Rollouts: Allows a single trajectory to contain segments from different weight versions, with all contributing versions tagged in the final sample.
Filtering tags: These tags allow the training engine 200 to perform off-policy corrections or filter out stale samples.

With respect to robustness and failure handling, the interface protocol is configured for large-scale data center stability using one or more of: idempotency, metadata atomicity, and worker recovery. Idempotency refers to operations that can be performed multiple times without changing the result beyond the initial operation. In the context of the rollout engine interface 273, for example, if a request for a weight or rollout is repeated with the same ID, the existing object is returned rather than creating a duplicate object.

With respect to metadata atomicity, weight metadata is never revoked until the rollout engine interface 273 confirms that the corresponding fetch has successfully completed. In terms of worker recovery, if a node (e.g., worker, instance, etc.) fails mid-generation, the request is marked FAILED, allowing the training side engine 200 to decide on a retry strategy.

Thus, the rollout engine interface 273 performs the role of a central controller for weight updates, rollout requests, and reliability management. For example, after the training engine instances 210-211 register their weight shards with the shard registration logic 250, the training engine 200 sends a POST/weight/create request to the rollout engine interface 273 containing the metadata. The rollout engine interface 273 then broadcasts the metadata to all its local tensor-parallel and data-parallel workers 270-271. Once all workers 270-271 finish fetching and updating, the rollout engine interface 273 transitions the weight state to AVAILABLE and sends a notification message 285 to the training engine 200.

In some embodiments, the POST/request/create sent by the training engine 200 indicates version constraints (e.g., min_weight_version: 17). When the rollout engine interface 273 assigns the task to a worker 270-271, it ensures that the current weight_version_used falls within the range requested in the POST/request/create. In addition, when a worker 270-271 returns a sample, the interface 273 tags it with the specific weight_version_used (and multiple versions if can_mix was enabled). The training engine 200 then performs a GET/request/sample in its request for weight data 286 to the rollout engine interface 273 to collect the tagged data for the next training iteration.

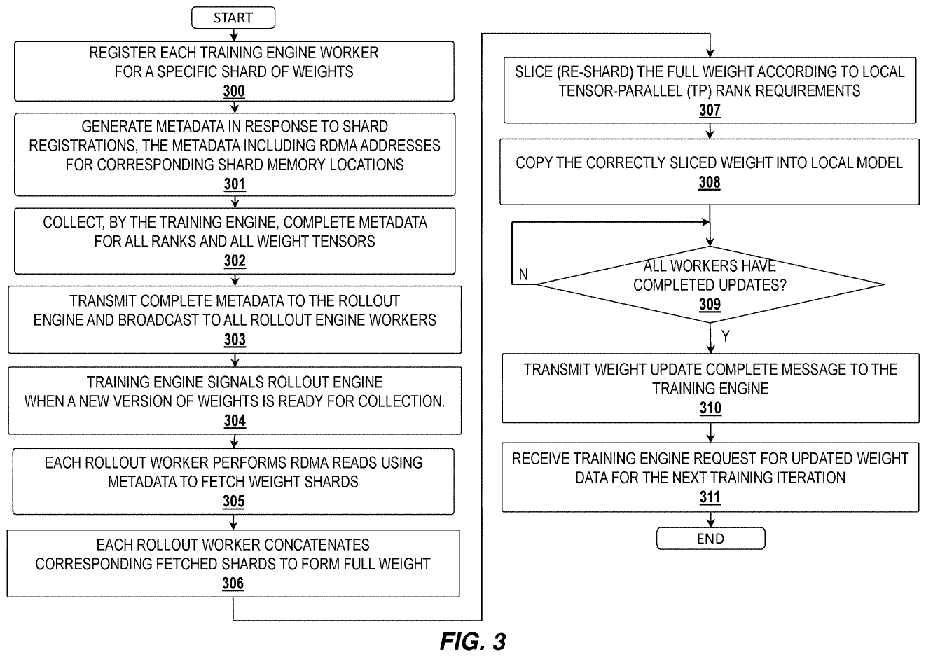

FIG. 3 illustrates a method in accordance with some embodiments of this disclosure. The method may be implemented on the specific processor and accelerator architectures described herein, but is not limited to any particular processor or accelerator architecture.

At 300, each training engine worker (e.g., each GPGPU instance) is registered for a specific shard of weights and, at 301, metadata is generated (e.g., by a weight transfer engine) in response to the shard registrations, the metadata including RDMA addresses for corresponding shard memory locations.

At 302, the complete metadata is collected (e.g., by the training engine) for all ranks and all weight tensors and, at 303, the complete metadata is transmitted to the rollout engine (e.g., via the rollout engine interface 273 of the RE driver 275) and then broadcast to all rollout engine workers.

At 304, the training engine signals to the rollout engine when a new version of weights is ready for collection and, at 305, each rollout worker responsively performs RDMA reads over the data plane, in accordance with the broadcast metadata to fetch corresponding weight shards.

At 306, each rollout worker concatenates corresponding fetched shards to form each respective full model weight and, at 306, each full weight is sliced (re-sharded) according to rollout engine worker local tensor-parallel (TP) rank requirements. At 307, the re-sharded/sliced weight is coped into the local model.

When all workers have completed their respective weight updates to the local model, determined at 309, then at 310, a message is transmitted to the training engine to indicate that the weight updates are complete, allowing the training engine to proceed to the next training phase iteration. At 311, the rollout engine receives a request from the training engine for the updated weight data for the next training iteration.

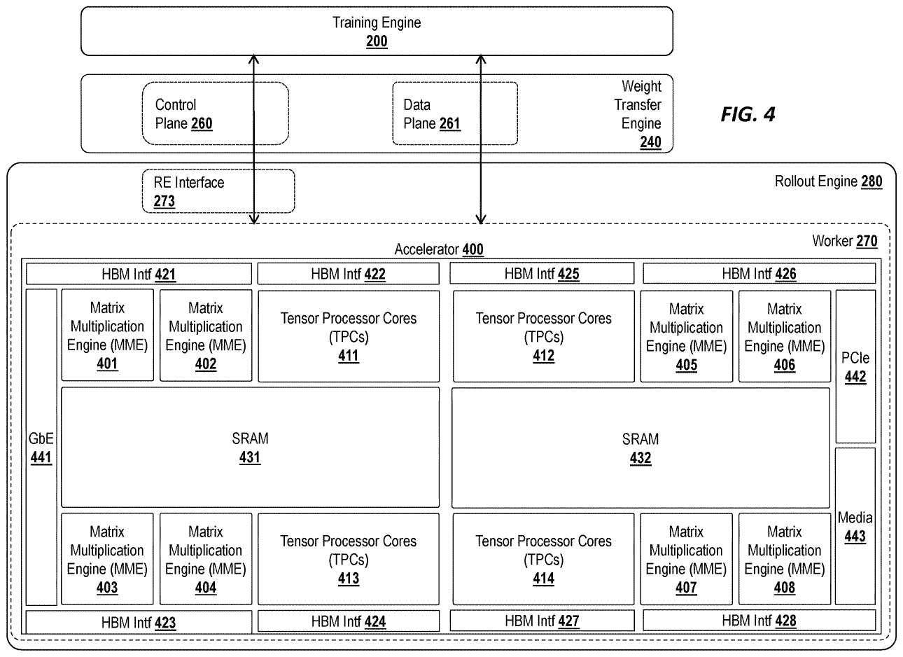

FIG. 4 illustrates an example accelerator 400 configurable as a worker 270 within the rollout engine 280. As previously described, each worker 270 is coupled to the training engine 200 via a control plane 260 and data plane 261 supported by the scale-out network of the weight transfer engine 240. The rollout engine interface 273 performs various control functions as described herein via the control plane 260 to ensure data coherency and synchronization of weight data communicated between the training engine 200 and the rollout engine 280 via the data plane 261. In some embodiments, the RE interface 273 is exposed by the RE driver 275 and is implemented in firmware and/or software executed by a host processor (not shown).

The illustrated accelerator 400 comprises heterogeneous processing capabilities, i.e., a plurality of matrix multiplication engines (MMEs) 401-408 and a plurality of tensor processor cores (TPCs) 411-414. The MMEs 401-408 are responsible for executing operations which can be reduced to matrix multiplications (e.g., fully connected layers, convolutions, batched-GEMM, etc.) while the TPCs 411-414 are very large instruction word (VLIW) single-instruction multiple-data (SIMD) processors configured specifically for deep learning operations. For example, the TPCs 411-414 operate in accordance with an instruction set and hardware tailored to serve training workloads efficiently. The TPCs are programmable and provide various workload-oriented features, such as non-GEMM operation acceleration, tensor addressing, latency hiding capabilities, and random number generation.

The MMEs 401-408 and TPCs 411-414 are coupled to High Bandwidth Memory (HBM) devices via high speed HBM interfaces 421-428. In various embodiments described herein, the queues associated with each processor type are allocated in the HBM or in a system memory 491 to store the attention operations associated with an attention graph. The accelerator device may also include dedicated scheduling hardware and software (not shown) for submitting the attention operations to the device-type queues.

The accelerator is coupled to a host processor 490 and system memory 491 via one or more PCIe interfaces 442 and/or gigabit Ethernet interfaces 441. For example, in some embodiments, the host processor 490 executes a scheduler (e.g., implemented in firmware or software) which submits attention operations to the device-type queues in system memory 491 or HBM. The illustrated embodiment also includes media logic 443 for performing various forms of multimedia encode/decode operations as described herein.

While TPCs 411-414 and MMEs 401-408 are used as examples of heterogeneous processors, the underlying principles of this disclosure may be implemented on different architectures having alternate sets of heterogeneous processors, such as central processing units (CPUs), graphics processors (GPUs), neural processing units (NPUs), and digital signal processors (DSPs).

Thus, embodiments of this disclosure include a heterogeneous reinforcement learning system architecture that runs the training engine 200 and corresponding instances 210-211 on high powered data parallel processors (e.g., GPGPUs) and runs the rollout engine 280 on lower-powered and lower-cost accelerators 190-191 to fully exploit the distinctive capabilities and price points of the heterogeneous processors. These embodiments include a heterogeneous weight transfer engine 240 which interfaces to the different hardware architectures and enables efficient weight updates from the training engine 200 to the rollout engine 280. A rollout engine interface 273 implements a protocol with weight and sample versioning that can encompass various reinforcement algorithms, including synchronized and asynchronized reinforcement learning algorithms.

A heterogeneous reinforcement system architecture described herein can leverage accelerator to perform efficient rollout operations to provide a differentiated and more efficient solution. By way of example, and not limitation, when the accelerators are Intel Gaudi3 accelerators, up to 2.11× absolute token throughput and 2.58×TCO benefit can be achieved over the Nvidia H100 executing both training and rollout engine workloads.

### EXAMPLES

The following are example implementations of different embodiments of the invention.

Example 1. A system, comprising: a first one or more processors to perform large language model (LLM) inference operations based on a current model version and to generate corresponding training data samples; a second one or more processors having a heterogeneous architecture relative to the first one or more processors, the second one or more processors configurable to perform reinforcement learning operations using the corresponding training data samples to update model weights for the current model version; and a weight transfer engine to provide point-to-point communication channels between the first one or more processors and the second one or more processors, the second one or more processors to transmit the model weights over the point-to-point communication channels to the first one or more processors.

Example 2. The system of Example 1, wherein the second one or more processors comprise general purpose graphics processing units (GPGPUs) and the first one or more processors comprise artificial intelligence (AI) accelerators.

Example 3. The system of Example 1, wherein the second one or more processors are to be configured as a training engine comprising a plurality of training instances to perform training operations for a corresponding plurality of shards of the model weights.

Example 4. The system of Example 3, wherein the weight transfer engine comprises registration logic to register each training instance to process a different shard of the corresponding plurality of shards of the model weights and to generate metadata corresponding to the plurality of shards.

Example 5. The system of Example 4, wherein the metadata is to indicate, for the plurality of shards, a corresponding plurality of memory addresses, each memory address to indicate a memory location of a respective shard of the model weights.

Example 6. The system of Example 5, wherein the first one or more processors are configurable as a rollout engine comprising a plurality of rollout engine workers, each rollout engine worker to determine, based on the metadata, a respective memory address of the plurality of memory address from which to access a corresponding shard of the model weights.

Example 7. The system of Example 6, wherein each rollout engine worker of the plurality of rollout engine workers is to perform a remote direct memory access (RDMA) operation using a respective memory address of the plurality of memory addresses to read a corresponding shard of the model weights, and to use the shard to update a corresponding local model, the rollout engine worker to perform the LLM inference operations using the corresponding local model to generate the corresponding training data samples.

Example 8. The system of Example 6, wherein the weight transfer engine further comprises: a data plane configurable to establish the point-to-point communication channels to perform a separate RDMA operation for each respective rollout engine worker; and a control plane over which the training engine is to transmit the metadata to the plurality of rollout engine workers.

Example 9. The system of Example 8, wherein the rollout engine further comprises a rollout engine interface to receive a first notification message from the training engine over the control plane when the training operations for the corresponding plurality of shards of the model weights are complete.

Example 10. The system of Example 9, wherein the rollout engine interface is to transmit a second notification message over the control plane to the training engine when the corresponding training data samples are available.

Example 11. An apparatus, comprising: a first one or more processors to perform large language model (LLM) inference operations based on a current model version and to generate corresponding training data samples; a weight transfer engine to provide point-to-point communication channels between the first one or more processors and a second one or more processors, the second one or more processors having a heterogeneous architecture relative to the first one or more processors, the second one or more processors configurable to perform reinforcement learning operations using the corresponding training data samples to update model weights for the current model version and to transmit the model weights over the point-to-point communication channels to the first one or more processors.

Example 12. The apparatus of Example 11, wherein the first one or more processors comprise artificial intelligence (AI) accelerators and the second one or more processors comprise general purpose graphics processing units (GPGPUs).

Example 13. The apparatus of Example 11, wherein the second one or more processors are to be configured as a training engine comprising a plurality of training instances to perform training operations for a corresponding plurality of shards of the model weights.

Example 14. The apparatus of Example 13, wherein the weight transfer engine comprises registration logic to register each training instance to process a different shard of the corresponding plurality of shards of the model weights and to generate metadata corresponding to the plurality of shards.

Example 15. The apparatus of Example 14, wherein the metadata is to indicate, for the plurality of shards, a corresponding plurality of memory addresses, each memory address to indicate a memory location of a respective shard of the model weights.

Example 16. The apparatus of Example 15, wherein the first one or more processors are configurable as a rollout engine comprising a plurality of rollout engine workers, each rollout engine worker to determine, based on the metadata, a respective memory address of the plurality of memory address from which to access a corresponding shard of the model weights.

Example 17. The apparatus of Example 16, wherein each rollout engine worker of the plurality of rollout engine workers is to perform a remote direct memory access (RDMA) operation using a respective memory address of the plurality of memory addresses to read a corresponding shard of the model weights and to use the shard to update a corresponding local model, the rollout engine worker to perform the LLM inference operations using the corresponding local model to generate the corresponding training data samples.

Example 18. The apparatus of Example 16, wherein the weight transfer engine further comprises: a data plane configurable to establish the point-to-point communication channels to perform a separate RDMA operation for each respective rollout engine worker; and a control plane over which the training engine is to transmit the metadata to the plurality of rollout engine workers.

Example 19. The apparatus of Example 18, wherein the rollout engine further comprises a rollout engine interface to receive a first notification message from the training engine over the control plane when the training operations for the corresponding plurality of shards of the model weights are complete.

Example 20. The apparatus of Example 19, wherein the rollout engine interface is to transmit a second notification message over the control plane to the training engine when the corresponding training data samples are available.

Example 21. A machine-readable medium having program code stored thereon which, when executed by one or more processors, is to cause the one or more processors to perform operations, comprising: registering each training engine instance of a training engine to process a specific shard of model weights of a large language model (LLM), each training engine instance executed by a first one or more processors; generating metadata in response to registering, the metadata including remote direct memory access (RDMA) addresses for corresponding shard memory locations; performing, by each rollout engine worker of a rollout engine, RDMA read operations using the metadata to fetch corresponding weight shards, the rollout engine executed by a second one or more processors heterogeneous with respect to the first one or more processors; updating weights of a local model in accordance with the weight shards; and performing LLM inference operations based on the local model to generate corresponding training data samples.

Example 22. The machine-readable medium of Example 21, further comprising program code to cause the second one or more processors to perform the operations of: performing reinforcement learning operations using the corresponding training data samples to update current model weights for the LLM; and selectively providing the current model weights to each rollout engine worker of the rollout engine in accordance with the RDMA read operations.

Example 23. The machine-readable medium of Example 22, wherein each rollout engine worker is to: concatenate corresponding weight shards accessed via the RDMA read operations to form a corresponding full weight; re-shard the corresponding full weight according to a local tensor-parallel (TP) rank requirement; and copy the re-sharded corresponding full weight into the local model.

Example 24. The machine-readable medium of Example 22, further comprising program code to cause the second one or more processors to perform the operations of: collecting, by the training engine, the metadata generated in response to the registering; and transmitting the metadata to the rollout engine, the metadata to be broadcast to the rollout engine workers.

Example 25. The machine-readable medium of Example 24, wherein communication between the training engine and the rollout engine is performed via a weight transfer engine comprising a data plane configurable to perform the RDMA read operations via point-to-point communication channels, and a control plane for transmitting the metadata to the rollout engine.

Example 26. The machine-readable medium of Example 25, wherein the rollout engine is to receive a first notification message from the training engine over the control plane when the current model weights for the LLM have been updated.

Embodiments of this disclosure may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment may be implemented using different combinations of software, firmware, and/or hardware.

Throughout this detailed description, for the purposes of explanation, numerous specific details were set forth in order to provide a thorough understanding of the present disclosure. It will be apparent, however, to one skilled in the art that these embodiments may be practiced without some of these specific details. In certain instances, well known structures and functions were not described in elaborate detail in order to avoid obscuring the subject matter of the present disclosure. Accordingly, the scope and spirit of the invention should be judged in terms of the claims which follow.

What is claimed is:

1. A system, comprising:
a first one or more processors to perform large language model (LLM) inference operations based on a current model version and to generate corresponding training data samples;
a second one or more processors having a heterogeneous architecture relative to the first one or more processors, the second one or more processors configurable to perform reinforcement learning operations using the corresponding training data samples to update model weights for the current model version; and
a weight transfer engine to provide point-to-point communication channels between the first one or more processors and the second one or more processors, the second one or more processors to transmit the model weights over the point-to-point communication channels to the first one or more processors.

2. The system of claim 1, wherein the second one or more processors comprise general purpose graphics processing units (GPGPUs) and the first one or more processors comprise artificial intelligence (AI) accelerators.

3. The system of claim 1, wherein the second one or more processors are to be configured as a training engine comprising a plurality of training instances to perform training operations for a corresponding plurality of shards of the model weights.

4. The system of claim 3, wherein the weight transfer engine comprises registration logic to register each training instance to process a different shard of the corresponding plurality of shards of the model weights and to generate metadata corresponding to the plurality of shards.

5. The system of claim 4, wherein the metadata is to indicate, for the plurality of shards, a corresponding plurality of memory addresses, each memory address to indicate a memory location of a respective shard of the model weights.

6. The system of claim 5, wherein the first one or more processors are configurable as a rollout engine comprising a plurality of rollout engine workers, each rollout engine worker to determine, based on the metadata, a respective memory address of the plurality of memory address from which to access a corresponding shard of the model weights.

7. The system of claim 6, wherein each rollout engine worker of the plurality of rollout engine workers is to perform a remote direct memory access (RDMA) operation using a respective memory address of the plurality of memory addresses to read a corresponding shard of the model weights, and to use the shard to update a corresponding local model, the rollout engine worker to perform the LLM inference operations using the corresponding local model to generate the corresponding training data samples.

8. The system of claim 6, wherein the weight transfer engine further comprises: a data plane configurable to establish the point-to-point communication channels to perform a separate RDMA operation for each respective rollout engine worker; and a control plane over which the training engine is to transmit the metadata to the plurality of rollout engine workers.

9. The system of claim 8, wherein the rollout engine further comprises a rollout engine interface to receive a first notification message from the training engine over the control plane when the training operations for the corresponding plurality of shards of the model weights are complete.

10. The system of claim 9, wherein the rollout engine interface is to transmit a second notification message over the control plane to the training engine when the corresponding training data samples are available.

11. An apparatus, comprising:
a first one or more processors to perform large language model (LLM) inference operations based on a current model version and to generate corresponding training data samples;
a weight transfer engine to provide point-to-point communication channels between the first one or more processors and a second one or more processors, the second one or more processors having a heterogeneous architecture relative to the first one or more processors, the second one or more processors configurable to perform reinforcement learning operations using the corresponding training data samples to update model weights for the current model version and to transmit the model weights over the point-to-point communication channels to the first one or more processors.

12. The apparatus of claim 11, wherein the first one or more processors comprise artificial intelligence (AI) accelerators and the second one or more processors comprise general purpose graphics processing units (GPGPUs).

13. The apparatus of claim 11, wherein the second one or more processors are to be configured as a training engine comprising a plurality of training instances to perform training operations for a corresponding plurality of shards of the model weights.

14. The apparatus of claim 13, wherein the weight transfer engine comprises registration logic to register each training instance to process a different shard of the corresponding plurality of shards of the model weights and to generate metadata corresponding to the plurality of shards.

15. The apparatus of claim 14, wherein the metadata is to indicate, for the plurality of shards, a corresponding plurality of memory addresses, each memory address to indicate a memory location of a respective shard of the model weights.

16. The apparatus of claim 15, wherein the first one or more processors are configurable as a rollout engine comprising a plurality of rollout engine workers, each rollout engine worker to determine, based on the metadata, a respective memory address of the plurality of memory address from which to access a corresponding shard of the model weights.

17. The apparatus of claim 16, wherein each rollout engine worker of the plurality of rollout engine workers is to perform a remote direct memory access (RDMA) operation using a respective memory address of the plurality of memory addresses to read a corresponding shard of the model weights and to use the shard to update a corresponding local model, the rollout engine worker to perform the LLM inference operations using the corresponding local model to generate the corresponding training data samples.

18. A machine-readable medium having program code stored thereon which, when executed by one or more processors, is to cause the one or more processors to perform operations, comprising:
registering each training engine instance of a training engine to process a specific shard of model weights of a large language model (LLM), each training engine instance executed by a first one or more processors;
generating metadata in response to registering, the metadata including remote direct memory access (RDMA) addresses for corresponding shard memory locations;
performing, by each rollout engine worker of a rollout engine, RDMA read operations using the metadata to fetch corresponding weight shards, the rollout engine executed by a second one or more processors heterogeneous with respect to the first one or more processors;
updating weights of a local model in accordance with the weight shards; and
performing LLM inference operations based on the local model to generate corresponding training data samples.

19. The machine-readable medium of claim 18, further comprising program code to cause the second one or more processors to perform the operations of:
performing reinforcement learning operations using the corresponding training data samples to update current model weights for the LLM; and
selectively providing the current model weights to each rollout engine worker of the rollout engine in accordance with the RDMA read operations.

20. The machine-readable medium of claim 19, wherein each rollout engine worker is to:
concatenate corresponding weight shards accessed via the RDMA read operations to form a corresponding full weight;
re-shard the corresponding full weight according to a local tensor-parallel (TP) rank requirement; and
copy the re-sharded corresponding full weight into the local model.
